(19) United States
(12) Patent Application Publication
(10) Pub. No.: US 2013/0191099 A1
(43) Pub. Date: Jul. 25, 2013

(54) PROCESS FOR GENERATING A COMPUTER-ACCESSIBLE MEDIUM INCLUDING INFORMATION ON THE FUNCTIONING OF A JOINT

(71) Applicant: Peter Roelof Krekel, The Hague (NL)

(72) Inventor: Peter Roelof Krekel, The Hague (NL)

(21) Appl. No.: 13/738,694

(22) Filed: Jan. 10, 2013

(30) Foreign Application Priority Data
Jan. 19, 2012 (NL) NL 2008143
Mar. 9, 2012 (NL) NL 2008437

(51) Int. Cl. G06N 3/00

(52) U.S. Cl. CPC G06N 3/00
USPC 703/11

(57) ABSTRACT

A process for generating a computer-accessible medium including information on the functioning of a joint includes the following steps: (i) obtaining an image dataset with the aid of a radiological examination of the joint, (ii) building a computer model of the joint using the image dataset, (iii) performing a biomechanical or kinematic simulation using the computer model and determining one or more biomechanical or kinematic simulation results, and (iv) receiving the biomechanical or kinematic simulation results as a multimedia object and integrating the multimedia object with a computer-accessible medium.

### CROSS-REFERENCE TO RELATED APPLICATION

Not applicable.

### FEDERALLY SPONSORED RESEARCH OR DEVELOPMENT

Not applicable.

### BACKGROUND

The invention relates to a process to generate a computer-accessible medium comprising information on the functioning of a joint.

From Krekel 2006 (Krekel, P. R.; Botha, C. P.; Valstar, E. R.; DeBruin, P. W.; Post, F. H.; Rozing, P. M., “Interactive simulation and comparative visualisation of the bone-determined range of motion of the human shoulder,” In: Schulze, T.; Horton, G.; Preim, B.; Schlechtweg, S., Proc. of SimVis., SCS Publishing House Erlangen 2006; pp. 275-288), it is known that surgeons can plan operations on the joint using 3 dimensional models of the specific joint. The 3 dimensional model is developed using CT-data of the joint and subsequently extracting surface models. Bone-determined Range of Motion (ROM) is automatically determined by systematically reorienting, for example, the humerus with placed humeral component in all directions, starting from an initial abduction of 45°, while checking for collisions with a collision detection algorithm. ROM is the area through which the humerus may be freely and painlessly moved.

A disadvantage of the above method is that a surgeon needs knowledge of the functioning of the computer program to run the 3 dimensional model. Furthermore, calculation power is required to run this 3-dimensional model requiring more complicated and expensive hardware at the end user. A next disadvantage is that the surgeon or the radiologist will need to spend time to operate the computer program and to assess if the ROM of a joint is limited.

### SUMMARY

The present invention aims at simplifying the use of 3-dimensional (3D) models when analyzing the ROM of a specific joint. This is achieved by the following process. Process to generate a computer-accessible medium, comprising information on the functioning of a joint, wherein the computer-accessible medium comprises an executable instruction to run a multimedia object by

(i) obtaining an image dataset with the aid of a radiological examination of the joint;

(ii) building a 3D-computer model of the joint using the image dataset;

(iii) performing a biomechanical or kinematic simulation using the computer model; and

(iv) receiving the biomechanical or kinematic simulation results as a multimedia object and integrating the multimedia object with a computer-accessible medium.

The above process is advantageous because the end user, for example the radiologist or the surgeon, can easily access the computer-accessible medium and does not have to install any additional software to run the integrated multimedia object. The only software to install is the software to run the computer-accessible medium. Preferably, the computer-accessible medium will require software which is generally available or installed on computers of the end users. The computer required to run the computer accessible medium is typically simpler than the computer to perform the biomechanical or kinematic simulation of the joint in step (iii). Thus with the present process it has become possible to review the biomechanical and/or kinematic functioning of a joint using a simple software program without having to use heavy computing power to run a biomechanical or kinematic simulation of the joint. Other advantages of the present invention will be discussed when describing the invention in detail.

In step (i) the image dataset is suitably obtained by a computed tomography (CT) system, a magnetic resonance imaging (MRI) system, a positron emission tomography system, an x-ray device or an ultrasound device. Preferably the image dataset is obtained by a computed tomography system or by a magnetic resonance imaging (MRI) system.

In step (ii) a model is built of the joint using the image dataset obtained in step (i). Building a model may be performed as described in Krekel 2010 (Krekel, P. R.; Valstar, E. R.; Post, F. H.; Rozing, P. M.; Botha, C. P., “Combined surface and volume processing for fused joint segmentation,” The International Journal for Computer Assisted Radiology and Surgery (2010; 5(3), pp. 263-273.), or, for example, as described in US2011/0235887. The model is a computer model and will be further referred to as a 3D-computer model. The 3D-computer model enables the user to visualize movement of a joint.

In step (iii) a biomechanical or kinematic simulation of the joint is performed using the 3D-computer model. Preferably, more than one movement of the joint is simulated. In these simulations it may be found that bone collision occurs at a specific movement of the joint. Suitably, a simulation dataset based on the simulation results is generated in step (iii), comprising data relating to the position and orientation of the joint members and data relating to the points of bone collision if found in the simulation. Preferably, the available joint space between the joint members is part of the simulation dataset. Preferably, a number of movements of the joint are performed to cover the whole range of motion (ROM) of the joint. In this manner a complete dataset is obtained for the ROM of the joint under investigation. This simulation dataset may also comprise information regarding the patient, such as name, age, sex, medical history, and patient identification number. Preferably, the simulation dataset also comprises data relating to proposed surgical modifications. The simulation dataset so obtained is suitably operable with the 3D-model of the joint as obtained in step (ii) to produce a time-ordered series of frames, wherein each frame consists of a 2D or 3D representation of a position and an orientation and/or a state of tissue types in the joint.

Preferably, the simulation dataset and the 3D-computer model are combined with an interactive viewer in step (iv) to obtain an interactive 3D-model as the multimedia object which is integrated with the computer-accessible medium. A preferred interactive viewer is a programmable viewer based on JavaScript.

In step (iii) the 3D-model is preferably used to obtain a relevant biomechanical or kinematic simulation result or results, and in step (iv) the relevant biomechanical or kinematic simulation results are received as a multimedia object and integrated with a computer-accessible medium. In the context of the present invention, a “relevant” result either relates to the malfunctioning of a joint, or, in the absence of any malfunctioning of the joint, to a result showing a healthy functioning of the joint. Because the multimedia object is created from the relevant results of the biomechanical or kinematic simulation, it is possible to give the end user direct and immediate access to these relevant results. This simplifies the speed of diagnostic evaluation and reduces the risk of missing relevant ROM deterioration.

Suitably, the relevant malfunctioning of the joint relates to the function of deformed joints, of injured joints or joints with planned or already present prosthetic parts. Suitably, the 3D-computer model of the joint is used in step (iii) to analyze a range of motion (ROM) of the joint, and determine situations of bone collisions or situations of no bone collision as the relevant biomechanical or kinematic simulation results. In this process, a motion of the joint is analyzed. Preferably, a number of predetermined motion patterns are tested. These motion patterns are typical for a specific joint. If no bone collision is determined, a next motion of the joint is analyzed. If a bone collision is determined, a multimedia object is created showing the movement of the joint and the bone collision as the relevant biomechanical or kinematic simulation result. Preferably, the area of bone collision is indicated by a contrasting color, for example red, relative to the color used for the bone parts, for example grey, of the joint. The above analysis of the motion of the joint within the range of motion (ROM) is preferably repeated until all possible movements have been analyzed. If more than one bone collision is determined, more multimedia objects may be created showing the relevant biomechanical or kinematic simulation results. If no bone collision is determined within the ROM, it is preferred that a multimedia object is created showing one or multiple healthy motion patterns of the joint as the relevant result. The relevant biomechanical or kinematic simulation results are suitably saved as a multimedia object and more preferably as part of a simulation dataset as described above. The simulation dataset may, in combination with the 3D-model, be viewed as a time-ordered series of frames, each frame consisting of a 2D or 3D representation of a position and an orientation and/or a state of tissue types in the joint. The multimedia object or simulation dataset is used in step (iv).

Preferably, the computer-accessible medium of step (iv) is a Portable Document Format, also called PDF document, or an HTML document. The PDF document can be read by the free Adobe® Acrobat Reader® viewer, starting from the Version 7.0. Adobe® Acrobat Reader is a product obtainable from Adobe Systems. Such a viewer should be able to present 2D or 3D multimedia objects as embedded in the PDF document on the screen of the user. The HTML document can be read with an appropriate Internet browser, such as Microsoft Internet Explorer or Google Chrome. The browser will enable to present the 2D or 3D multimedia objects on the screen of the user.

An appropriate PDF Viewer or Internet browser is practically present on each computer, so that the end-user of the computer-accessible medium does not have to install any additional software in order to retrieve the relevant biomechanical or kinematic simulation results as a multimedia object. The multimedia object is therefore suitably a device-independent object.

Step (iv) is preferably performed using Acrobat Adobe Pro Extended when integrating the multimedia object with a PDF document. Integrating 2D and 3D multimedia objects into PDF documents is a well-known feature of this software. Preferably, the simulation dataset obtained in step (iii) and the 3D-computer model obtained in step (ii) are combined with an interactive viewer in step (iv) to obtain an interactive 3D-model as the multimedia object which is embedded with the computer-accessible medium. A preferred interactive viewer is a programmable viewer based on JavaScript. The interactive viewer may be programmed to provide user-executable buttons, for example mouse-operated executable buttons, which can initiate predefined tasks. An example of a predefined task may be a time-ordered series of frames, each frame consisting of a 2D or 3D representation of a position and an orientation and/or a state of tissue types in the joint, for the “relevant” biomechanical or kinematic simulation result. Another example may be the manipulation by the user of the embedded 3D model, wherein the visual presentation of the joint movements is directly shown in the multimedia object. Another example is where a visual presentation is shown of the simulated range of motion for relevant motion patterns of the joint.

The computer-accessible medium, preferably the PDF or HTML document, may also comprise additional information regarding the functioning of the joint. Additional information may, for example, be information indicating the patient, such as, for example, name, age, sex, medical history, and patient identification number. Preferably, the computer-accessible medium comprises additional information derived from the image dataset with the aid of a radiological examination of the joint as obtained in step (i) or additional information derived from the model as obtained in step (ii). More preferably, the computer-accessible medium comprises an interactive 3D model of the joint based on the computer model as obtained in step (ii), and wherein the computer-accessible medium comprises executable instructions to interact with the 3D model. The interactive 3D model of the joint is suitably a device-independent object.

The invention is also directed to the following process. Process to generate a computer-accessible medium comprising information on the functioning of a joint, wherein the computer-accessible medium comprises an executable instruction to run a multimedia object by

(a) obtaining an image dataset with the aid of a radiological examination of the joint;

(b) building a 3D-computer model of the joint from the image dataset;

(c) performing a biomechanical or kinematic simulation of the joint using the computer model wherein more than one movement of the joint is simulated and wherein bone collision may happen at a specific movement of the joint, and creating a simulation dataset based on the resulting simulation results, the simulation dataset comprising data relating to the oriental positioning of the joint members for a specific movement and data relating to the points of bone collision, provided that bone collision is detected by the simulation; and

(d) combining an interactive viewer, the simulation dataset and the 3D-computer model and embedding the resulting interactive 3D-model in a computer-accessible medium.

Steps (a) and (b) may be performed as steps (i) and (ii). Steps (c) and (d) may be performed as described for steps (iii) and (iv). When further reference is made to steps (i), (ii), (iii) and (iv) one may also read steps (a), (b), (c) and (d).Steps (ii)-(iv) are preferably performed on a single computer platform and more preferably in an automated process requiring minimal interaction. The product of this process, namely the computer-accessible medium, can be provided to the end-user, e.g., the surgeon or the radiologist, by email or via a suitable carrier, such as, for example, a USB stick and the like, or it may be placed on a central data carrier, for example a server, which is accessible by said end-user. Steps (ii)-(iv) may be performed at a different location than the location at which step (i) is performed. In a preferred embodiment, steps (ii)-(iv) are performed at a single location, wherein step (i) is performed at different locations. In this manner, step (i) can be performed near the patient's regular hospital, while the production of the computer-accessible medium products can be performed at a more central location servicing more than one hospital. In this manner, heavy computing power and software required to perform steps (ii)-(iv) have to be present at fewer locations than the number of locations where step (i) is performed.

The invention is also directed to the use of the computer-accessible medium, as obtained by the above process, to diagnose the functioning of a joint. The end user preferably has suitable software installed to view the computer-accessible medium. If the computer-accessible medium is a PDF document, a PDF reader, such as Acrobat Reader 7.0 or higher, is preferably installed on his or her computer or on the central computer network. If the computer-accessible medium is an HTML document, a suitable Internet browser is installed on his or her computer or on the central computer network.

The computer-accessible medium as obtained by the above process may also be used to explain the functioning of a joint to a patient. This may, for example, be when visiting the surgeon or radiologist or at home.

### BRIEF DESCRIPTION OF THE DRAWINGS

The invention will be illustrated by means of the following Figures:

FIG. 1 shows the process steps to generate a computer-accessible medium comprising information on the functioning of a joint.

FIG. 2 shows a process wherein the computer model of the joint is used to analyse a range of motions of the joint.

FIG. 3 shows an example of how the relevant biomechanical or kinematic simulation result(s) may be presented as an embedded document in a computer-accessible medium.

FIG. 4 is a flow chart illustrating a process in accordance with a preferred embodiment of the present invention.

### DETAILED DESCRIPTION

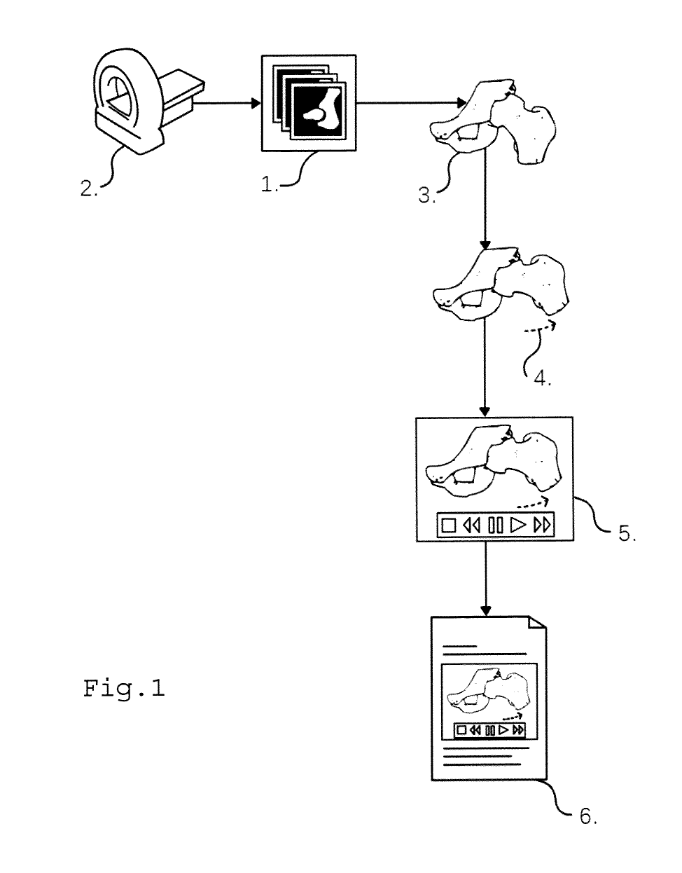

FIG. 1 shows the process steps to generate a computer-accessible medium comprising information on the functioning of a joint. In step (i), an image dataset 1 is obtained with the aid of a radiological examination 2 of the joint. In step (ii), a computer model of the joint 3 is built using the image dataset. Using this model, biomechanical or kinematic simulation of the joint 3 is performed, and one or more relevant biomechanical or kinematic simulation results 4 are determined. The relevant biomechanical or kinematic simulations are received in step (iv) as a multimedia object 5. This multimedia object 5 is subsequently integrated with a computer-accessible medium 6.

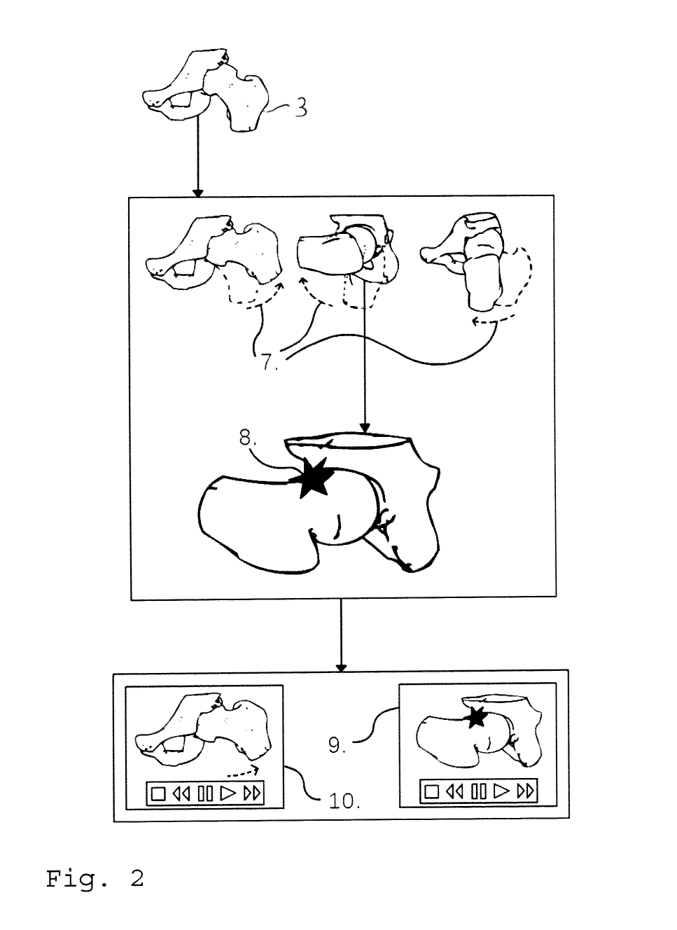

FIG. 2 shows a process wherein the computer model of the joint 3 is used to analyze a range of motions 7 of the joint 3. If a situation of bone collisions 8 is determined, it is qualified as a relevant biomechanical or kinematic simulation result. A first-type multimedia object 9 is created showing the relevant biomechanical or kinematic simulation result. If no bone collision is determined within the ROM, a second-type multimedia object 10 is created showing the functioning of a healthy joint.

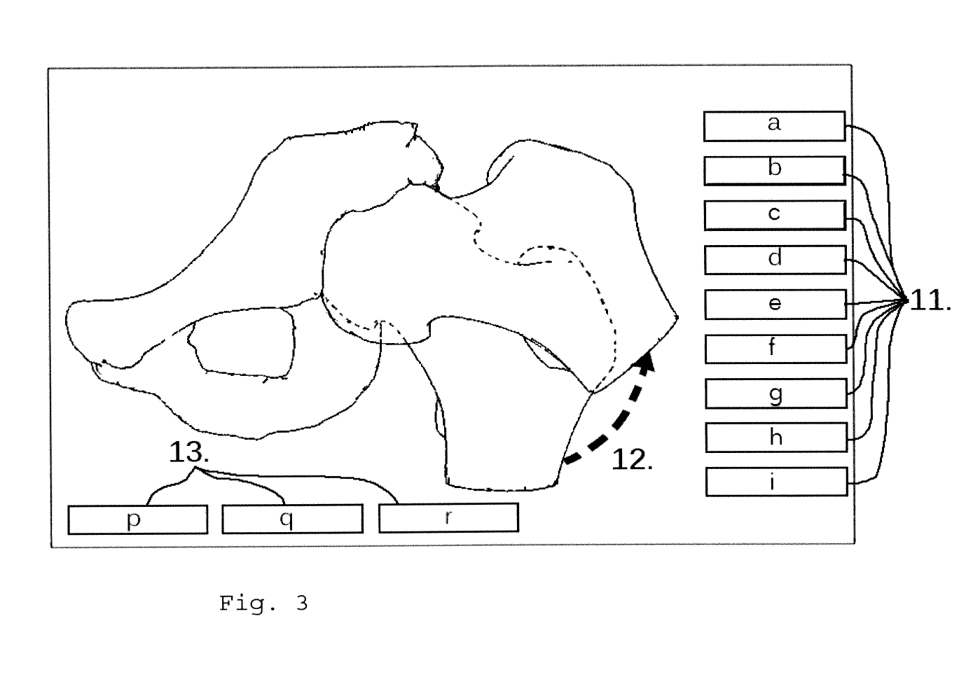

FIG. 3 shows an example of how the relevant biomechanical or kinematic simulation result(s) may be presented as an embedded document in a computer-accessible medium. FIG. 3 only shows the box with the embedded information. Several executable buttons 11a-11i are present which the user can activate. A first button 11a may be labelled “abduction,” and it will show the biomechanically simulated available range of motion for an abduction (sideways) motion pattern as a multimedia object 12. The end-user will know that by executing this labelled button, the relevant biomechanical or kinematic simulation result will be presented. If he or she requires more information regarding the joint, such as manipulating an embedded 3D model, one or more of supplemental executable buttons 13p, 13q, and 13r may be executed. Manipulations of an embedded 3D model are directly shown in the multimedia object and may lead to different biomechanical simulation results. The executable buttons 11a-11i will now show the biomechanically simulated available range of motion for relevant motion patterns of the manipulated embedded 3D model, rather than the original 3D model.

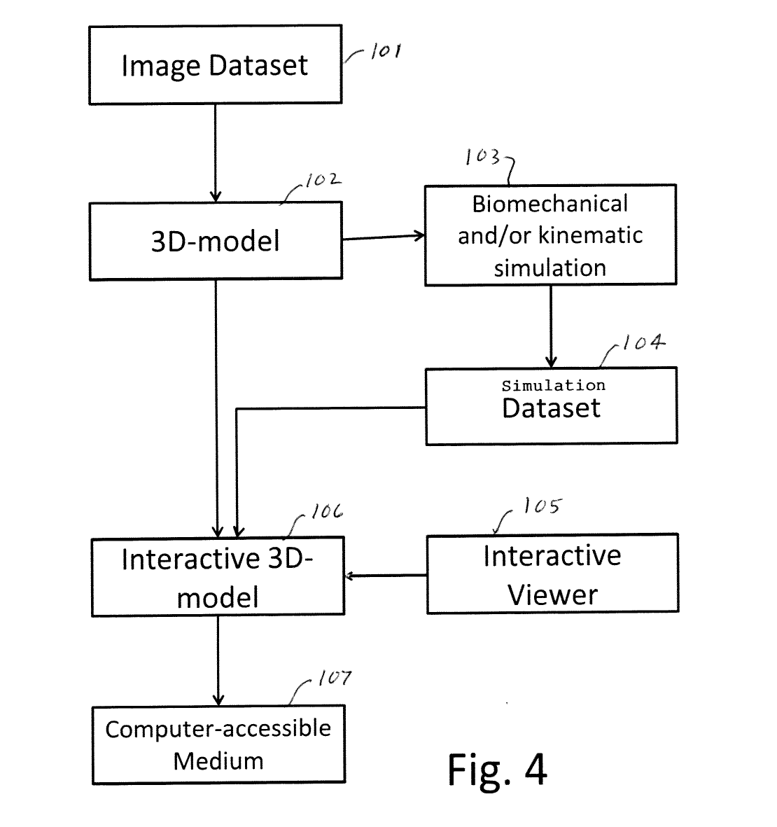

FIG. 4 illustrates a preferred embodiment of the present invention wherein in step (iii) a simulation dataset is generated. As shown first, an Image Dataset 101 is obtained of the joint. Based on the Image Dataset, a 3D-model 102 is built and subsequently used to perform a biomechanical and/or kinematic simulation 103. This simulation generates a simulation dataset 104 that includes data relating to the oriented positioning of the joint members for a specific movement and data relating to the points of bone collision, provided that a bone collision is detected by the simulation. The simulation dataset 104 is combined with the 3D-model 102 and an Interactive Viewer 105 to obtain an interactive 3D-model 106. The interactive 3D-model is subsequently embedded in a computer-accessible medium 107.

What is claimed is:

1. A process for generating a computer-accessible medium comprising information on the functioning of a joint, wherein the computer-accessible medium comprises an executable instruction to run a multimedia object, the process comprising:
(i) obtaining an image dataset with the aid of a radiological examination of the joint;
(ii) building a 3D-computer model of the joint using the image dataset;
(iii) performing a biomechanical or kinematic simulation using the computer model to obtain biomechanical or kinematic simulation results; and
(iv) receiving the biomechanical or kinematic simulation results as a multimedia object and integrating the multimedia object with a computer-accessible medium.

2. A process according to claim 1, wherein in step (iii) one or more relevant biomechanical or kinematic simulation results are determined, and wherein in step (iv) the relevant biomechanical or kinematic simulation results are received as a multimedia object and integrated with a computer-accessible medium.

3. A process according to either of claim 1 or 2, wherein the computer-accessible medium comprises an interactive 3D model of the joint based on the computer model as obtained in step (ii), and wherein the computer-accessible medium comprises executable instructions to interact with the 3D model.

4. A process according to claim 3, wherein in step (iii) a biomechanical or kinematic simulation of the joint is performed using the 3D-computer model, wherein more than one movement of the joint is simulated, wherein bone collision may happen at a specific movement of the joint, wherein step (iii) includes creating a simulation dataset based on the resulting biomechanical or kinematic simulation results, the simulation dataset comprising data relating to the oriented positioning of the joint members for a specific movement and data relating to the points of bone collision, provided that bone collision is detected by the simulation, and wherein in step (iv) the interactive 3D-model is obtained by combining an interactive viewer, the simulation dataset and the 3D-computer model obtained in step (ii).

5. A process according to claim 4, wherein the simulation dataset obtained in step (iii) also comprises data relating to proposed surgical modifications.

6. A process according to either of claim 1 or 2, wherein the computer-accessible medium is a PDF document.

7. A process according to either of claim 1 or 2, wherein the computer-accessible medium is a HTML document.

8. A process according to either of claim 1 or 2, wherein the multimedia object is a device-independent object.

9. A process according to either of claim 1 or 2, wherein the image dataset is obtained by a method selected from the group consisting of computed tomography (CT), magnetic resonance imaging (MRI), positron emission tomography, x-rays, and ultrasound.

10. A process according to claim 9, wherein the image dataset is obtained by a method selected from the group consisting of computed tomography (CT) and magnetic resonance imaging (MRI).

11. A process according to either of claim 1 or 2, wherein the biomechanical or kinematic simulation results relate to a joint function, wherein the joint function is selected from the group consisting of one or more of a deformed joint function, an injured joint function, and a joint function for a joint with planned or already present prosthetic parts.

12. A process according to claim 2, wherein the 3D-computer model of the joint is used in step (iii) to analyze a range of motions of the joint and determine situations of bone collision or of no bone collision as the relevant biomechanical or kinematic simulation results, and to create a multimedia object showing the relevant biomechanical or kinematic simulation results for use in step (iv).

13. A process according to either of claim 1 or 2, wherein the computer accessible medium comprises an interactive 3D model of the joint based on the computer model as obtained in step (ii), wherein the computer-accessible medium comprises executable instructions to interact with the 3D model, and wherein the computer accessible medium is selected from the group consisting of a PDF document and an HTML document.

14. A process according to claim 13, wherein the biomechanical or kinematic simulation results relate to a joint function, wherein the joint function is selected from the group consisting of one or more of a deformed joint function, an injured joint function, and a joint function for a joint with planned or already present prosthetic parts.

15. Use of the computer-accessible medium as obtained by the process of claim 13 to diagnose a functioning of a joint.

16. A process for generating a computer-accessible medium comprising information on the functioning of a joint, wherein the computer-accessible medium comprises an executable instruction to run a multimedia object, the process comprising:
(a) obtaining an image dataset with the aid of a radiological examination of the joint;
(b) building a 3D-computer model of the joint using the image dataset;
(c) performing a biomechanical or kinematic simulation of the joint using the computer model wherein more than one movement of the joint is simulated and wherein bone collision may happen at a specific movement of the joint, and creating a simulation dataset based on the resulting simulation results, the simulation dataset comprising data relating to the oriented positioning of the joint members for a specific movement and data relating to the points of bone collision provided that bone collision is detected by the simulation; and
(d) combining an interactive viewer, the simulation dataset, and the 3D-computer model and embedding the resulting interactive 3D-model in a computer-accessible medium.
